(19) United States
(12) Patent Application Publication
(10) Pub. No.: US 2010/0027113 A1
(43) Pub. Date: Feb. 4, 2010

(54) DISPLAY DEVICE

(75) Inventors: Kyoung-Ju SHIN, Hwaseong-si (KR); Chong-Chul Chai, Seoul (KR); Hae-Young Yun, Suwon-si (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/493,019

(22) Filed: Jun. 26, 2009

(30) Foreign Application Priority Data
Aug. 1, 2008 (KR) 10-2008-0075644

(51) Int. Cl. G02B 27/22

(52) U.S. Cl. 359/463

(57) ABSTRACT

A display device of the present invention is capable of reducing stereoscopic image noise to improve the quality of a three-dimensional stereoscopic image. The display device includes a display panel having a plurality of pixels provided therein and displaying an image, a lenticular sheet provided on the display panel and having a plurality of first cylindrical lenses arranged on one surface and a second cylindrical lens for focusing light arranged on the other surface, and a backlight assembly provided below the display panel and emitting light to the display panel.

### CROSS REFERENCE TO RELATED APPLICATION

This application claims priority from and the benefit of Korean Patent Application No. 10-2008-0075644, filed on Aug. 1, 2008, which is hereby incorporated by reference for all purposes as if fully set forth herein.

### BACKGROUND OF THE INVENTION

1. Field of the Invention

The present invention relates to a display device, and more particularly, to a display device capable of reducing stereoscopic image noise to improve the quality of a stereoscopic image.

2. Discussion of the Background

With improvements made in information technology, there is an increasing demand for display devices having small size and thickness. However, CRT displays according to the related art are insufficient to meet the demand. Therefore, flat display devices, such as a PDP (plasma display panel), a PALC (plasma-addressed liquid crystal display panel), an LCD (liquid crystal display), and an OLED (organic light-emitting diode) device, are in great demand.

In recent years, the quality of display devices has been improved such that display devices can display a photograph-quality image, and display devices capable of displaying both a two-dimensional (2D) image and a three-dimensional (3D) image have been developed. A 3D display device displays a stereoscopic image using binocular parallax.

For example, stereoscopic glasses, a hologram, a lenticular sheet, or a barrier is used to form a 3D stereoscopic image.

Among these methods for forming a 3D stereoscopic image, in the method of using the lenticular sheet, a 2D image is separated into an image for the right eye and an image for the left eye by the lenticular sheet, and an object is stereoscopically viewed by the binocular parallax. However, in the method of using the lenticular sheet to form a 3D stereoscopic image, the image for the left eye and the image for the right eye may partially overlap each other. In this case, the overall quality of the image may deteriorate to cause the observer to feel dizzy. Therefore, a structure capable of clearly separating the image for the left eye from the image for the right eye is needed.

### SUMMARY OF THE INVENTION

The present invention provides a display device capable of reducing stereoscopic image noise to improve the quality of a three-dimensional stereoscopic image.

Additional features of the invention will be set forth in the description which follows, and in part will be apparent from the description, or may be learned by practice of the invention.

The present invention discloses a display device including a display panel having a plurality of pixels provided therein and displaying an image, a lenticular sheet provided on the display panel and having a plurality of first cylindrical lenses arranged on one surface and a second cylindrical lens for focusing light arranged on the other surface, and a backlight assembly provided below the display panel and emitting light to the display panel.

The present invention also discloses a display device including a display panel having a plurality of pixels provided therein and displaying an image, a lenticular sheet provided on the display panel and having a plurality of first cylindrical lenses arranged on one surface, a lens sheet provided between the lenticular sheet and the display panel and has a second cylindrical lens for focusing light arranged on one surface, and a backlight assembly provided below the display panel and emitting light to the display panel.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view schematically illustrating a display device according to a first embodiment of the invention.

FIG. 2 is a cross-sectional view illustrating the display device shown in FIG. 1.

FIG. 3 is a diagram illustrating the arrangement of pixels and first cylindrical lenses of the display device shown in FIG. 1.

FIG. 4 is a cross-sectional view schematically illustrating the operation of the display device shown in FIG. 1 forming a stereoscopic image.

FIG. 5A is a diagram illustrating an image displayed on the display device shown in FIG. 1, which is viewed by the left eye.

FIG. 5B is a diagram illustrating an image displayed on the display device shown in FIG. 1, which is viewed by the right eye.

FIG. 6 is a perspective view schematically illustrating a display device according to a second embodiment of the invention.

FIG. 7 is a cross-sectional view illustrating the display device shown in FIG. 6.

FIG. 8 is a diagram illustrating the arrangement of pixels and first cylindrical lenses of the display device shown in FIG. 6.

FIG. 9 is a cross-sectional view schematically illustrating the operation of the display device shown in FIG. 6 forming a stereoscopic image.

FIG. 10A is a diagram illustrating an image displayed on the display device shown in FIG. 6, which is viewed by the left eye.

FIG. 10B is a diagram illustrating an image displayed on the display device shown in FIG. 6, which is viewed by the right eye.

FIG. 11 is a perspective view schematically illustrating a display device according to a third embodiment of the invention.

FIG. 12 is a cross-sectional view illustrating the display device shown in FIG. 1.

FIG. 13 is a bottom perspective view illustrating a lenticular sheet of the display device shown in FIG. 1.

FIG. 14 is a perspective view schematically illustrating a display device according to a fourth embodiment of the invention.

FIG. 15 is a cross-sectional view illustrating the display device shown in FIG. 14.

FIG. 16 is a cross-sectional view schematically illustrating a display device according to a fifth embodiment of the invention.

FIG. 17 is a cross-sectional view schematically illustrating a display device according to a sixth embodiment of the invention.

FIG. 18 is an exploded perspective view illustrating a display device according to an embodiment of the invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

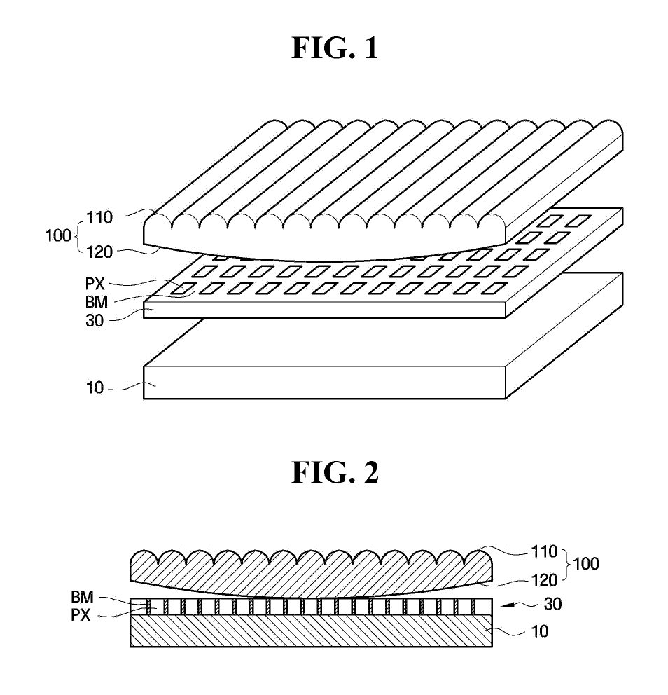

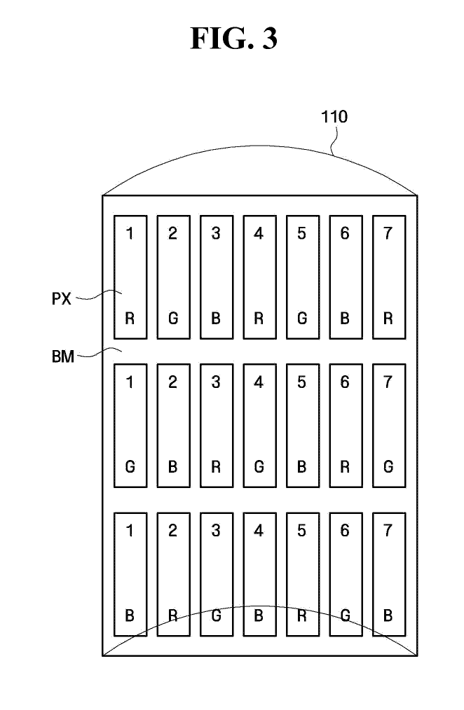

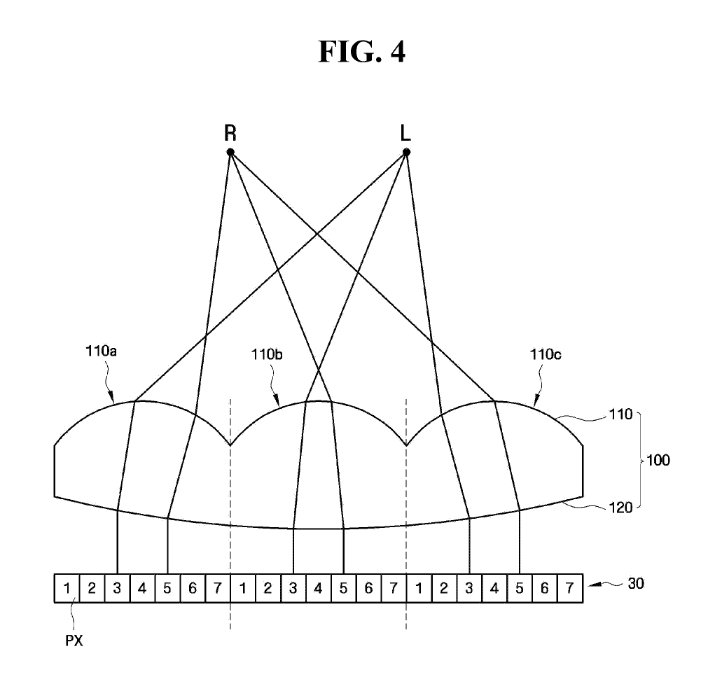

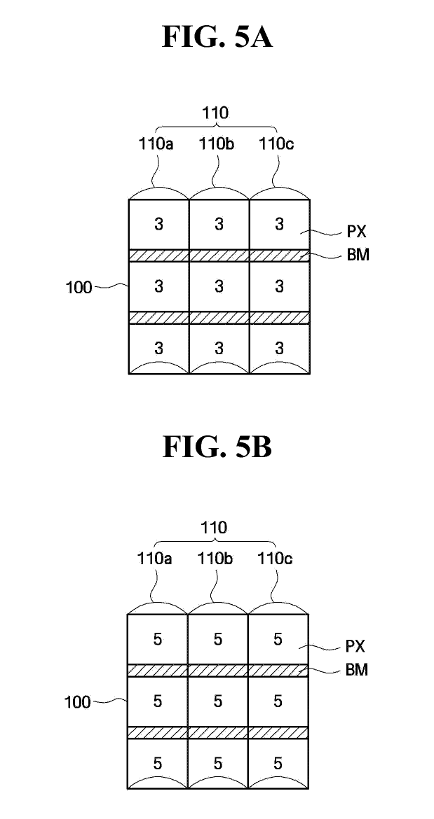

Hereinafter, a display device according to a first embodiment of the invention will be described in detail with reference to FIG. 1, FIG. 2, FIG. 3, FIG. 4, FIG. 5A, and FIG. 5B. FIG. 1 is a perspective view schematically illustrating the display device according to the first embodiment of the invention. FIG. 2 is a cross-sectional view illustrating the display device shown in FIG. 1. FIG. 3 is a diagram illustrating the arrangement of pixels and first cylindrical lenses of the display device shown in FIG. 1. FIG. 4 is a cross-sectional view schematically illustrating the operation of the display device shown in FIG. 1 in forming a stereoscopic image. FIG. 5A is a diagram illustrating an image displayed on the display device shown in FIG. 1, which is viewed by the left eye, and FIG. 5B is a diagram illustrating an image displayed on the display device shown in FIG. 1, which is viewed by the right eye.

Referring to FIG. 1 and FIG. 2, a display device 1 according to the first embodiment of the invention includes a lenticular sheet 100, a display panel 30, and a backlight assembly 10.

The lenticular sheet 100 enables pixels PX of the display panel 30 to be selectively viewed, and includes first cylindrical lenses 110 and a second cylindrical lens 120.

A plurality of first cylindrical lenses 110 are formed on one surface of the lenticular sheet 100, and the second cylindrical lens 120 is formed on the other surface thereof. The first cylindrical lenses 110 may be arranged on an observer side, and the second cylindrical lens 120 may be arranged so as to face the display panel 30.

The cylindrical lens means a lens that is formed in a convex shape on the one or the other surface of the lenticular sheet 100 so as to extend in a predetermined direction. That is, in the specification, the cylindrical lens may be formed by cutting a portion of a cylinder or a cylindroid in the vertical direction. The shape of the first cylindrical lens 110 or the second cylindrical lens 120 in a cross-sectional view may form a portion of a circle, or it may form a portion of an ellipse, if necessary.

The first cylindrical lens 110 and the second cylindrical lens 120 may alternatively be formed by cutting a portion of a prism in the vertical direction.

However, the first cylindrical lens 110 and the second cylindrical lens 120 are not limited to the above described shapes. For example, the lenses may be multifocal lenses having multiple foci or lenses having a plurality of sections.

The shape of the first cylindrical lens 110 or the second cylindrical lens 120 in a cross-sectional view may form a portion of a circle, or it may form a portion of an ellipse or a portion of a polygon, if necessary.

A direction that is parallel to a line passing through the vertex of a convex portion of the cylindrical lens is referred to as the axial direction of the lens, and the number of pixels PX overlapping the first cylindrical lens 110 in a perpendicular direction to the axial direction of the lens are the number of viewpoints that can be obtained by the display device.

The number of viewpoints means the number of positions where images captured in different directions are displayed when the display device is viewed at different positions, and also means the number of images captured at different points at the same time and displayed at the same time. For example, two viewpoints mean that the images captured at two points at the same time are displayed at the same time, and seven viewpoints mean that the images captured at seven points at the same time are displayed at the same time.

A plurality of first cylindrical lenses 110 are formed on the upper surface of the lenticular sheet 100, and one first cylindrical lens 110 is formed for the pixels that are equal to the number of viewpoints. Therefore, in a 7-viewpoint lens, one first cylindrical lens 110 is formed for seven pixels. That is, the number of first cylindrical lenses 110 may be a value obtained by dividing the number of pixels arranged along the gate lines (not shown) of the display panel 30 by the number of viewpoints.

The second cylindrical lens 120 refracts light such that a desired pixel PX can be exactly viewed. The second cylindrical lens 120 may be formed so as to focus light. One or more second cylindrical lenses 120 may be formed on the lower surface of the lenticular sheet 100. The second cylindrical lens 120 is formed on a surface opposite to the surface on which the first cylindrical lenses 110 are formed, and a plurality of second cylindrical lenses 120 may be formed, if necessary. However, in the specification, one second cylindrical lens 120 is formed on the lower surface of the lenticular sheet 100 so as to overlap all of the plurality of first cylindrical lenses 110.

The second cylindrical lens 120 may be arranged such that its axis is parallel to the axes of the first cylindrical lenses 110. That is, the first cylindrical lenses 110 and the second cylindrical lens 120 may extend in the same direction.

The second cylindrical lens 120 may be arranged so as to face the display panel, and it may be formed in a convex shape that protrudes toward the display panel 30. However, the second cylindrical lens 120 is not limited to a lens having a curved surface, but it may be formed in a shape having a continuous plane. That is, the second cylindrical lens 120 may have any shape as long as it can refract light passing through the lenticular sheet 100 in a predetermined direction.

The second cylindrical lens 120 may have a curvature radius that is larger than that of the first cylindrical lens 110. In this case, the focal distance of the second cylindrical lens 120 may be longer than that of the first cylindrical lens 110.

The second cylindrical lens 120 may be formed such that, as the distance from the center of the lens axis is increased, the curvature radius is decreased.

The display panel 30 displays an image and includes a plurality of pixels PX. The pixels PX are arranged in a matrix in the display panel 30. That is, the pixels may be arranged in a predetermined array in the horizontal and vertical directions. Each of the pixels PX displays any one of red, green, and blue to form an image. The display panel 30 may be a PDP (plasma display panel), a PALC (plasma address liquid crystal display panel), an LCD (liquid crystal display), or an OLED (organic light emitting diode) panel. However, in the specification, for clarity of description, an LCD is used as the display panel 30.

The backlight assembly 10 is arranged below the display panel 30. That is, since a passive display panel, such as the LCD, requires a separate light source, the backlight assembly 10 is provided to emit light to the display panel 30.

When the backlight assembly 10 emits light to the display panel 30, the display panel 30 displays various images. The lenticular sheet 100 allows the observer to view different images on the display panel 30 at different positions.

Next, the arrangement of the first cylindrical lenses 110 and the pixels PX will be described in detail with reference to FIG. 3. As shown in FIG. 2, the pixels PX are arranged in a matrix in the horizontal and vertical directions. The pixels PX may display different colors, and adjacent pixels PX may display images that are viewed as different images at different viewing angles.

The lenticular sheet 100 is formed on the pixels PX, and the pixels PX may be viewed through the first cylindrical lenses 110 formed on the upper surface of the lenticular sheet 100.

The first cylindrical lenses 110 may be focused on the pixel PX to be viewed.

Portions of the first cylindrical lenses 110 may have different focal distances.

The pixels PX may be formed in a matrix below the first cylindrical lenses 110, and a black matrix BM is formed between the pixels PX to shield light. Since the first cylindrical lenses 110 form a multi-view, the observer moves in a direction vertical to the axial direction of the lenses to view different images. That is, the first cylindrical lenses 110 may be formed such that different pixels PX are viewed according to the viewing direction of one first cylindrical lens 110. In order to form the multi-view, the first cylindrical lenses 110 and a plurality of pixels PX overlap each other in a direction that is vertical to the axial direction of the first cylindrical lenses 110, and the focal distance of the first cylindrical lenses 110 is adjusted. In this way, different pixels can be viewed according to the viewing angle.

The first cylindrical lenses 110 and the second cylindrical lens 120 may be arranged vertical to a virtual horizontal line linking the eyes of the observer, or they may be inclined at a predetermined angle with respect to the virtual horizontal line.

In particular, when the first cylindrical lenses 110 are arranged so as to be inclined at a predetermined angle with respect to the direction in which the pixels PX are arranged, it is possible to prevent black matrix moiré in which the black matrix BM formed between the pixels PX is viewed as a line.

Next, the view of a 3D stereoscopic image by the eyes of the observer will be described in detail with reference to FIG. 4.

The lenticular sheet 100 shown in FIG. 4 includes three first cylindrical lenses 110 and one second cylindrical lens 120, and each of the first cylindrical lenses 110 overlaps seven pixels PX. This structure is an illustrative example to describe the view of a 3D stereoscopic image, and may display a 7-viewpoint stereoscopic image.

The positions of the right and left eyes of the observer are defined on the basis of the observer, and the left and right sides of the lenticular sheet 100 and the display panel 30 are defined on the basis of the lenticular sheet 100 and the display panel 30. In the specification, the terms “left” and “right” are used for clarity of the description of the invention. If necessary, the “upper” and “lower” sides or the “front” and “rear” sides may be used.

The observer views the display panel 30 overlapped with the lenticular sheet 100 with the left eye L and right eye R.

The lenticular sheet 100 includes three first cylindrical lenses 110, that is, a left cylindrical lens 110a, a right cylindrical lens 110c, and a central cylindrical lens 110b. The lenticular sheet 100 may be divided into three equal parts, that is, the left cylindrical lens 110a, the right cylindrical lens 110c, and the cylindrical lens 110b.

Each of the left cylindrical lens 110a, the right cylindrical lens 110c, and the central cylindrical lens 110b overlaps seven pixels PX. The seven pixels PX display images captured at seven points, and form seven views. The observer views only two pixels PX among the seven pixels PX overlapped with each of the left cylindrical lens 110a, the right cylindrical lens 110c, and the central cylindrical lens 110b. The two pixels PX among the seven pixels PX form different views. The observer views one of the two pixels PX with the left eye L, and views the other pixels with the right eye R. The observer views the two pixels at different viewpoints to recognize a 3D stereoscopic image.

Next, the view of a 3D stereoscopic image by the observer will be described in detail.

Referring to FIG. 5A, when the observer views the pixels PX of the display panel 30 with the left eye L, only the third-viewpoint pixel PX is viewed in each of the left cylindrical lens 110a, the right cylindrical lens 110c, and the central cylindrical lens 110b. Specifically, when light passes through the third-viewpoint pixel PX, the light is primarily refracted by the second cylindrical lens 120 and then secondarily refracted by the first cylindrical lens 110. Light emitted from the third-viewpoint pixel PX of the display panel 30 is incident on the left eye L of the observer by a combination of the first cylindrical lens 110 and the second cylindrical lens 120.

Referring to FIG. 5B, when the observer views the pixels PX of the display panel 30 with the right eye R, only the fifth-viewpoint pixel PX is viewed in each of the left cylindrical lens 110a, the right cylindrical lens 110c, and the central cylindrical lens 110b. Specifically, when light passes through the fifth-viewpoint pixel PX, the light is primarily refracted by the second cylindrical lens 120 and then secondarily refracted by the first cylindrical lens 110. Light emitted from the fifth-viewpoint pixel PX of the display panel 30 is incident on the left eye L of the observer by a combination of the first cylindrical lens 110 and the second cylindrical lens 120.

Referring to FIG. 4, FIG. 5A, and FIG. 5B, the observer views only the third-viewpoint pixels PX on the entire surface of the display panel 30 with the left eye L, and views only the fifth-viewpoint pixels PX on the entire surface of the display panel 30 with the right eye R. Therefore, the observer can view completely separated images with the left eye L and the right eye R.

The first cylindrical lenses 110 may be formed on the entire surface of the lenticular sheet 100 so as to have the same shape and size, and the second cylindrical lens 120 may be formed on the entire surface of the lenticular sheet 100 so at to have different curvature radiuses. Therefore, the second cylindrical lens 120 may have a small curvature radius at a point where an angle formed between the viewing direction of the observer and a normal line of the surface of the first cylindrical lens 110 is large. On the other hand, the second cylindrical lens 120 may have a large curvature radius at a point where an angle formed between the viewing direction of the observer and a normal line of the surface of the first cylindrical lens 110 is small.

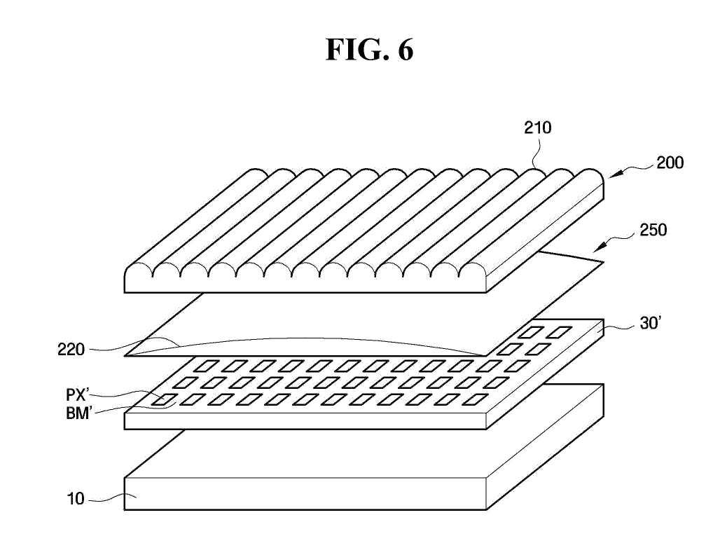

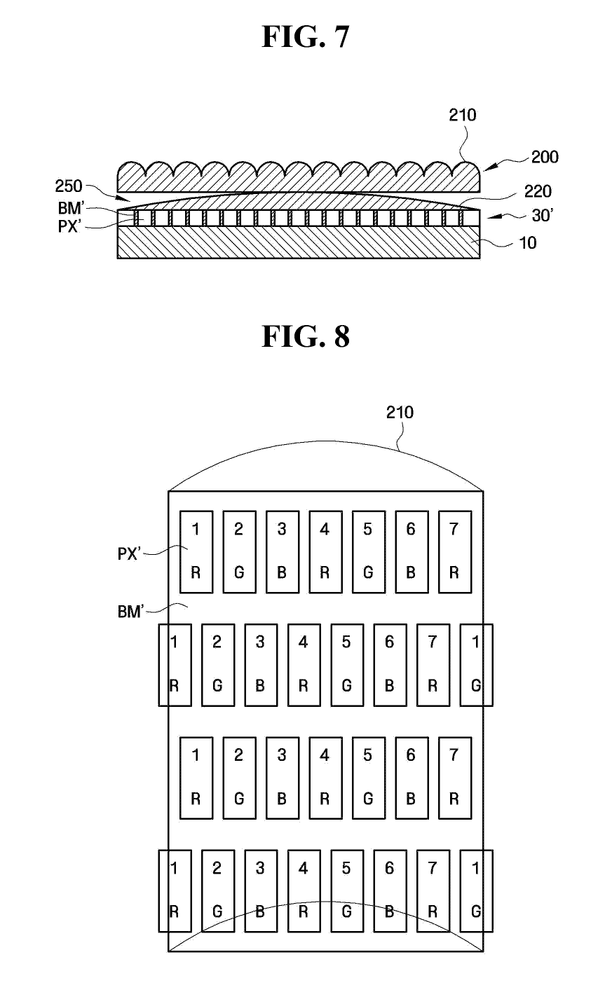

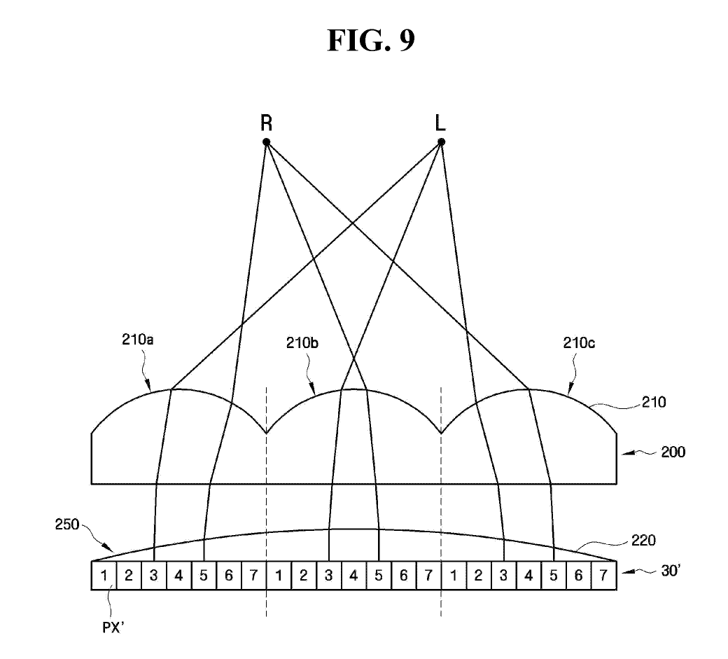

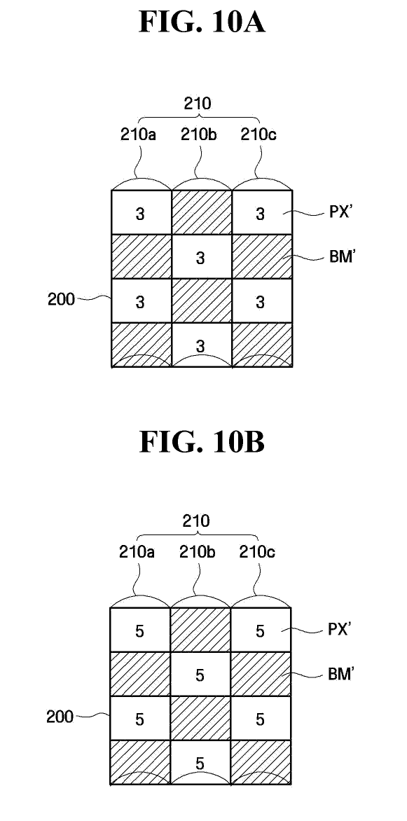

Next, a display device according to a second embodiment of the invention will be described in detail with reference to FIG. 6, FIG. 7, FIG. 8, FIG. 9, FIG. 10A, and FIG. 10B. FIG. 6 is a perspective view schematically illustrating a display device according to the second embodiment of the invention. FIG. 7 is a cross-sectional view illustrating the display device shown in FIG. 6. FIG. 8 is a diagram illustrating the arrangement of pixels and first cylindrical lenses of the display device shown in FIG. 6. FIG. 9 is a cross-sectional view schematically illustrating the operation of the display device shown in FIG. 6 in forming a 3D stereoscopic image. FIG. 10A is a diagram illustrating an image displayed on the display device shown in FIG. 6, which is viewed by the left eye, and FIG. 10B is a diagram illustrating an image displayed on the display device shown in FIG. 6, which is viewed by the right eye. For clarity of description, in the second embodiment, components having the same functions as those in the first embodiment are denoted by the same reference numerals and a description thereof will be omitted.

First, referring to FIG. 6 and FIG. 7, the display device according to the second embodiment of the invention includes a lenticular sheet 200, a lens sheet 250, a display panel 30′, and a backlight assembly 10.

The lenticular sheet 200 enables pixels PX′ of the display panel 30′ to be selectively viewed, and includes first cylindrical lenses 210 formed on the upper surface thereof. The lower surface of the lenticular sheet 200 may be flat, or it may be formed in a convex shape.

The lens sheet 250 is interposed between the lenticular sheet 200 and the display panel 30′. A second cylindrical lens 220 is formed on one surface of the lens sheet 250. The second cylindrical lens 220 may be formed on one surface of the lens sheet 250 facing the lenticular sheet 200, or it may be formed on the other surface of the lens sheet 250 facing the display panel 30′, if necessary. The other surface of the lens sheet 250 opposite to the one surface having the second cylindrical lens 220 formed thereon may be flat. Alternatively, convex lenses may be formed on both surfaces of the lens sheet 250.

The lenticular sheet 200 may include a plurality of first cylindrical lenses 210 formed on the upper surface thereof, and the lens sheet 250 may include one second cylindrical lens 220 formed on the upper surface thereof

Only one lens sheet 250 may be formed between the lenticular sheet 200 and the display panel 30′. Alternatively, a plurality of lens sheets 250 may be provided therebetween.

The second cylindrical lens 220 refracts light such that a desired pixel PX′ is exactly viewed, and is formed so as to focus light.

The second cylindrical lens 220 may have a curvature radius that is larger than that of the first cylindrical lenses 210. In this case, the focal distance of the second cylindrical lens 220 may be longer than that of the first cylindrical lenses 210.

The second cylindrical lens 220 may be formed such that, as the distance from the center of the lens axis is increased, the curvature radius is decreased.

Next, the arrangement of the first cylindrical lenses 210 and the pixels PX′ will be described in detail with reference to FIG. 8. As shown in FIG. 8, the pixels PX′ are arranged so as to slightly deviate from each other in the axial direction of the first cylindrical lenses 210. The pixels PX′ may be formed such that they deviate from each other by half the width of one pixel PX′ in the axial direction of the first cylindrical lenses 210. It is possible to prevent black matrix moiré in which a black matrix BM′ is viewed as a line by arranging the pixels PX′ so as to deviate from each other in the axial direction of the first cylindrical lenses 210.

The lenticular sheet 200 and the lens sheet 250 may be arranged in parallel to the axial directions of the first cylindrical lenses 210 and the second cylindrical lens 220, respectively.

The second cylindrical lens 220 may have a curvature radius that is larger than that of the first cylindrical lenses 210. In this case, the focal distance of the second cylindrical lens 220 may be longer than that of the first cylindrical lenses 210.

The second cylindrical lens 220 may be formed such that, as the distance from the center of the lens axis is increased, the curvature radius is decreased.

Next, the view of a 3D stereoscopic image by the eyes of the observer will be described in detail with reference to FIG. 9.

The lenticular sheet 200 shown in FIG. 9 includes three first cylindrical lenses 210 and one second cylindrical lens 220, and each of the first cylindrical lenses 210 overlaps seven pixels PX′. This structure is an illustrative example to describe the view of a stereoscopic image, and can display a 7-viewpoint stereoscopic image.

The lens sheet 250 having the second cylindrical lens 220 formed on the upper surface thereof is arranged below the lenticular sheet 200.

The lenticular sheet 200 includes three first cylindrical lenses 210, that is, a left cylindrical lens 210a, a right cylindrical lens 210c, and a central cylindrical lens 210b. The lenticular sheet 200 may be divided into three equal parts, that is, the left cylindrical lens 210a, the right cylindrical lens 210c, and the central cylindrical lens 210b.

Next, the view of a 3D stereoscopic image by the observer will be described in detail.

Referring to FIG. 10A, when the observer views the pixels PX′ of the display panel 30′ with the left eye L, only the third-viewpoint pixel PX′ is viewed in each of the left cylindrical lens 210a, the right cylindrical lens 210c, and the central cylindrical lens 210b. Specifically, when light passes through the third-viewpoint pixel PX′, the light is primarily refracted by the second cylindrical lens 220 and then secondarily refracted by the first cylindrical lenses 210. Light emitted from the third pixel PX′ of the display panel 30′ is incident on the left eye L of the observer by a combination of the first cylindrical lenses 210 and the second cylindrical lens 220.

The black matrix BM′ is provided between the pixels PX′ viewed by the left eye L. Since the black matrices BM′ and the pixels PX′ are alternately arranged, the black matrices BM′ are not actually viewed by the left eye L of the observer, and only the pixels PX′ are viewed.

Referring to FIG. 10B, when the observer views the pixels PX′ of the display panel 30′ with the right eye R, only the fifth-viewpoint pixel PX′ is viewed in each of the left cylindrical lens 210a, the right cylindrical lens 210c, and the central cylindrical lens 210b. Specifically, when light passes through the fifth-viewpoint pixel PX′, the light is primarily refracted by the second cylindrical lens 220 and then secondarily refracted by the first cylindrical lenses 210. Light emitted from the fifth-viewpoint pixel PX′ of the display panel 30′ is incident on the right eye R of the observer by a combination of the first cylindrical lenses 210 and the second cylindrical lens 220.

The black matrix BM′ is provided between the pixels PX′ viewed by the right eye R, similar to the pixels PX′ viewed by the left eye L. That is, since the black matrices BM′ and the pixels PX′ are alternately arranged, the black matrices BM′ are not viewed as a line, but exist as dots between the pixels PX′. Therefore, the black matrices BM′ are not actually viewed.

Referring to FIG. 8, FIG. 9, FIG. 10A, and FIG. 10B, the observer views only the third-viewpoint pixels PX′ on the entire surface of the display panel 30′ with the left eye L, and views only the fifth-viewpoint pixels PX′ on the entire surface of the display panel 30′ with the right eye R. Therefore, the observer can view completely separated images with the left eye L and the right eye R.

The first cylindrical lenses 210 may be formed on the entire surface of the lenticular sheet 200 so as to have the same shape and size, and the second cylindrical lens 220 may be formed on the entire surface of the lens sheet 250 so as to have different curvature radiuses. Therefore, the second cylindrical lens 220 may have a small curvature radius at a point where an angle formed between the viewing direction of the observer and a normal line of the surface of the first cylindrical lenses 210 is large. On the other hand, the second cylindrical lens 220 may have a large curvature radius at a point where the angle formed between the viewing direction of the observer and a normal line of the surface of the first cylindrical lenses 210 is small.

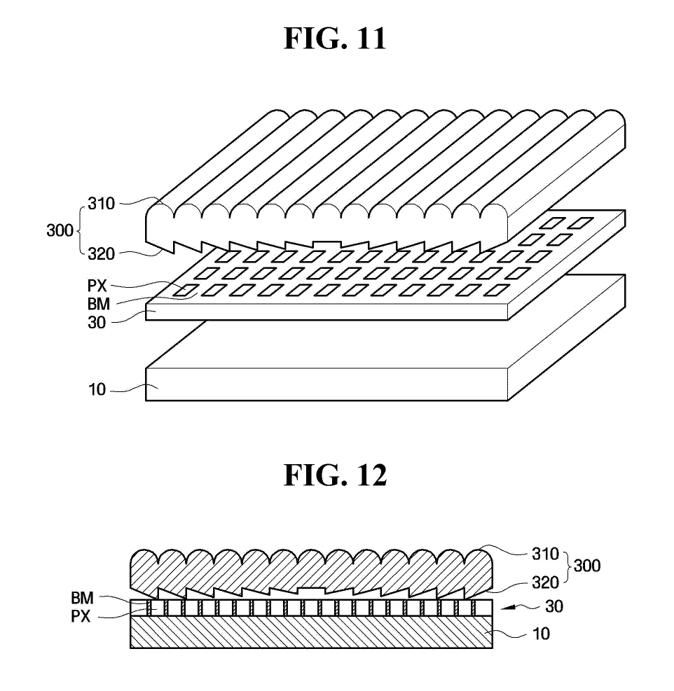

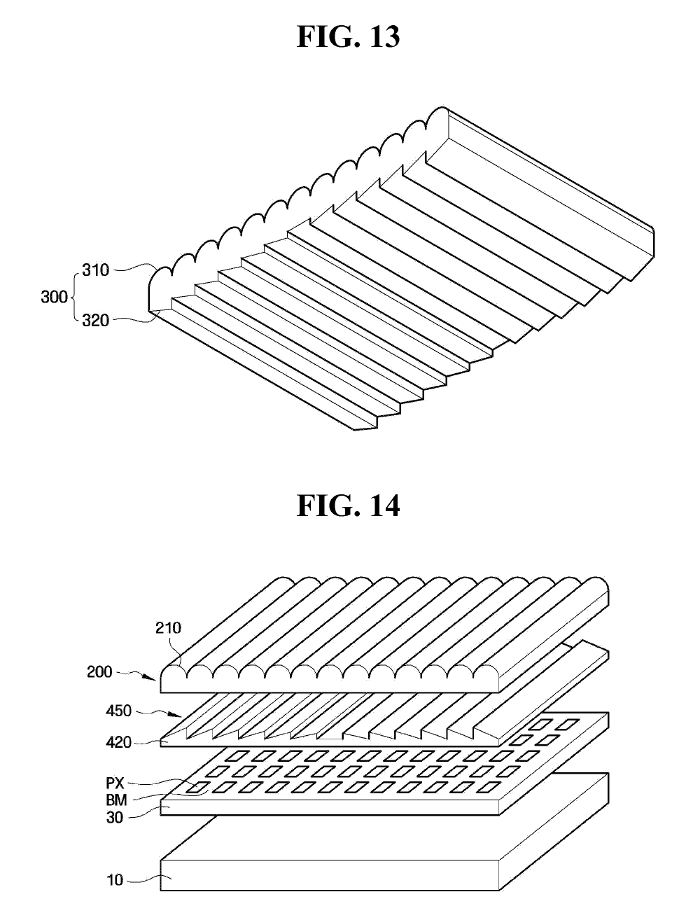

Next, a display device according to a third embodiment of the invention will be described in detail with reference to FIG. 11, FIG. 12, and FIG. 13. FIG. 11 is a perspective view schematically illustrating the display device according to the third embodiment of the invention. FIG. 12 is a cross-sectional view illustrating the display device shown in FIG. 11. FIG. 13 is a bottom perspective view illustrating a lenticular sheet of the display device shown in FIG. 11. For clarity of description, in the third embodiment, components having the same function as those in the first embodiment are denoted by the same reference numerals and a description thereof will be omitted.

The display device according to the third embodiment includes a lenticular sheet 300 having a second cylindrical lens 320 that is formed in a Fresnel lens shape. Specifically, the display device includes the lenticular sheet 300, a display panel 30, and a backlight assembly 10.

A plurality of first cylindrical lenses 310 are formed on the upper surface of the lenticular sheet 300 and the second cylindrical lens 320 having a Fresnel lens shape is formed on the lower surface thereof. When the second cylindrical lens 320 is formed in a Fresnel lens shape, it is possible to reduce the thickness of the second cylindrical lens 320. When the thickness of the second cylindrical lens 320 is reduced, the overall thickness of the lenticular sheet 300 is reduced.

The second cylindrical lens 320 may be formed of a convex Fresnel lens. The surface of the second cylindrical lens 320 may be curved, similar to one surface of the convex lens. However, the surface of the second cylindrical lens 320 is not necessarily limited to the curved surface, but it may be flat.

A positional deviation may occur in the pixels PX viewed through the first cylindrical lenses 310 depending on the position of the display panel 30. The second cylindrical lens 320 may be formed so as to correct the positional deviation. Therefore, the surface of the second cylindrical lens 320 is not limited to a curved surface or a flat surface, but it may be formed in any shape as long as the second cylindrical lens 320 can correct the positional deviation of the pixels PX viewed depending on the position of the display panel. For example, a portion of the surface of the second cylindrical lens 320 may be a curved surface, and the other portion thereof may be a flat surface. In addition, portions of the surface of the second cylindrical lens 320 may have different curvature radiuses.

The second cylindrical lens 320 may include a plurality of lens portions having different refracting surfaces, and each of the lens portions may have a width that is equal to that of the first cylindrical lenses 310.

A supporter (not shown) supporting the lenticular sheet 300 may be formed between the lenticular sheet 300 and the display panel 30.

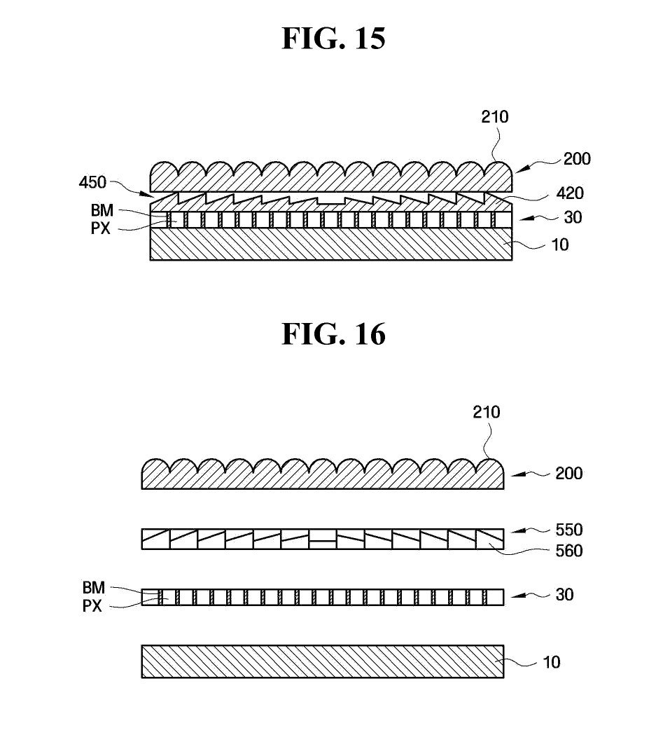

Next, a display device according to a fourth embodiment of the invention will be described in detail with reference to FIG. 14 and FIG. 15. FIG. 14 is a perspective view schematically illustrating the display device according to the fourth embodiment of the invention, and FIG. 15 is a cross-sectional view illustrating the display device shown in FIG. 14. For clarity of description, in the fourth embodiment, components having the same functions as those in the first embodiment are denoted by the same reference numerals and a description thereof will be omitted.

The display device according to the fourth embodiment of the invention includes a lens sheet 450 having a second cylindrical lens 420 that is formed in a Fresnel lens shape. Specifically, the display device includes a lenticular sheet 200, the lens sheet 450, a display panel 30, and a backlight assembly 10.

The lens sheet 450 is interposed between the lenticular sheet 200 and the display panel 30. The lenticular sheet 200 has first cylindrical lenses 210 formed on the upper surface thereof, and the second cylindrical lens 420 is formed on one surface of the lens sheet 450. The second cylindrical lens 420 may be formed in a convex lens shape that focuses light, or it may be formed in a Fresnel lens shape. The second cylindrical lens 420 may be formed on one surface of the lens sheet 450 facing the lenticular sheet 200, or it may be formed on the other surface of the lens sheet 450 facing the display panel 30. The other surface of the lens sheet 450 opposite to the one surface on which the second cylindrical lens 420 is formed may be flat. Alternatively, convex lenses may be formed on both surfaces of the lens sheet 450.

Only one lens sheet 450 may be formed between the lenticular sheet 200 and the display panel 30, or a plurality of lens sheets 450 may be formed therebetween, if necessary.

Next, a display device according to a fifth embodiment of the invention will be described in detail with reference to FIG. 16. FIG. 16 is a cross-sectional view schematically illustrating the display device according to the fifth embodiment of the invention. For clarity of description, in the fifth embodiment, components having the same functions as those in the first embodiment are denoted by the same reference numerals and a description thereof will be omitted.

The display device according to the fifth embodiment of the invention includes a lens sheet 550 having a second cylindrical lens 560 of a liquid lens type. In the specification, the term lens sheet 550 is used for convenience of description. However the lens sheet 550 is not limited to a thin sheet, but may be a plate or a lens array substrate having a plurality of lenses formed thereon.

The second cylindrical lens 560 may be a liquid lens that changes an interface between two liquids having different refractive indexes to adjust a refracting angle. The liquid lens may have a structure in which a voltage is applied to two liquids having different refractive indices to incline the interface between the two liquids at a predetermined angle, such that the liquids serve as a convex lens or a concave lens.

In the lens sheet 550, the second cylindrical lens 560, which is a liquid lens, may be arranged in parallel to the first cylindrical lenses 210, and the refracting surface of the second cylindrical lens 560 varies depending on a voltage applied. Therefore, as described above, the second cylindrical lens 560 can correct the positional deviation of the pixels PX viewed through the first cylindrical lenses 210. The second cylindrical lens 560 of a liquid lens type can adjust the refracting angle in real time according to the position of the observer or the conditions of the display device. Therefore, the second cylindrical lens 560 can actively correspond to use conditions.

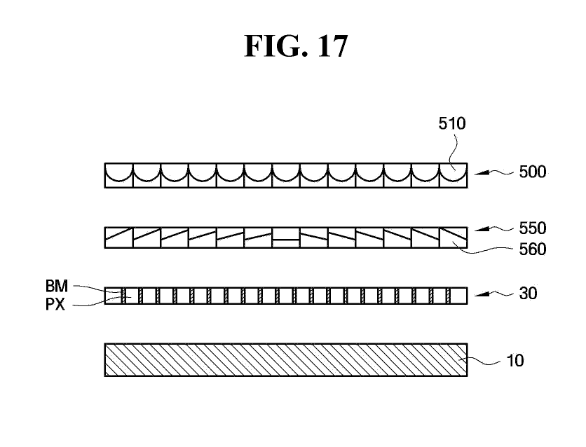

Next, a display device according to a sixth embodiment of the invention will be described in detail with reference to FIG. 17. FIG. 17 is a cross-sectional view schematically illustrating the display device according to the sixth embodiment of the invention. For clarity of description, in the sixth embodiment, components having the same functions as those in the first embodiment are denoted by the same reference numerals and a description thereof will be omitted.

The display device according to the sixth embodiment of the invention includes a lenticular sheet 500 having a first cylindrical lens 510 of a liquid lens type and a lens sheet 550 having a second cylindrical lens 560 of a liquid lens type.

Since the first cylindrical lens 510 and the second cylindrical lens 560 are formed of liquid lenses, it is possible to change the focal distances of the first cylindrical lens 510 and the second cylindrical lens 560 and the angles of the refracting surfaces thereof.

When the first cylindrical lens 510 is composed of a liquid crystal lens or a liquid lens, it is possible to adjust the focal distance and the angle of the refracting surface of the lens. Therefore, it is possible to display both a two-dimensional image and a three-dimensional image. For example, when the refracting surface of the first cylindrical lens 510 is adjusted parallel to the display panel 30, it is difficult to form a multi-view image using the first cylindrical lens 510. As a result, only a two-dimensional image is displayed.

On the other hand, when the first cylindrical lens 510 is composed of a cylindrical lens, which is a convex lens, as described in the first to fifth embodiments, it is possible to form a multi-view image using the first cylindrical lens 510. As a result, it is possible to display a 3D stereoscopic image.

Further, it is possible to adjust the number of viewpoints of the observer by changing the focal distance of the first cylindrical lens 510. Therefore, it is possible to switch a view mode to a 2-viewpoint mode when a multi-view is not needed in a specific environment. When the multi-view mode is switched to the 2-viewpoint mode, the resolution may be relatively improved.

When the observer is moved while viewing the display device, the view mode may be switched to the multi-view mode in order to obtain a soft stereoscopic image.

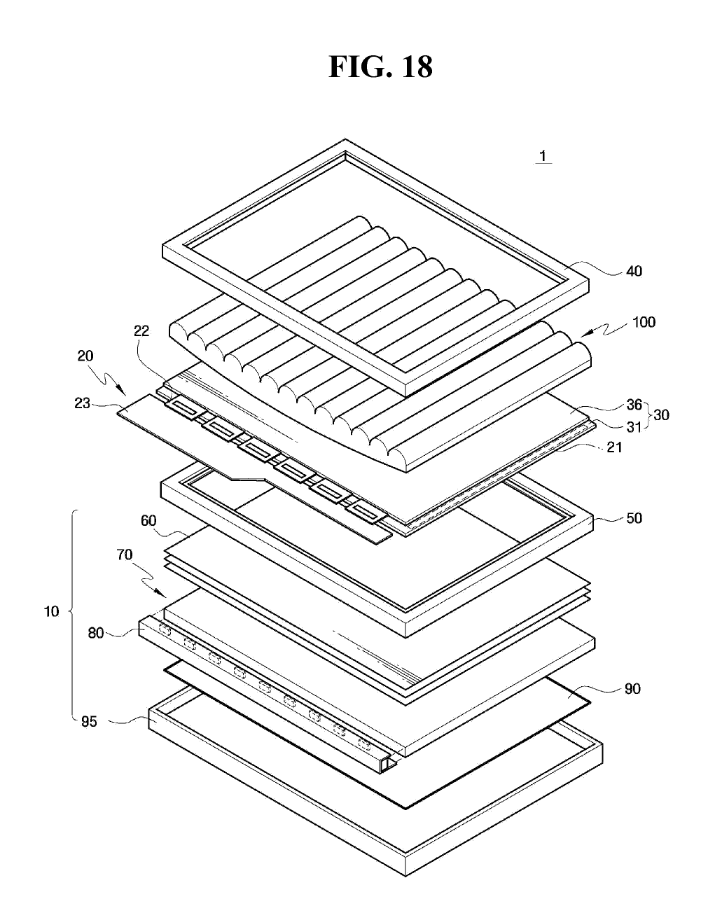

Next, a display device according to an embodiment of the invention will be described in detail with reference to FIG. 18. FIG. 18 is an exploded perspective view illustrating the display device according to an embodiment of the invention.

The display device according to the invention includes a lower display panel 31 having a thin film transistor array formed thereon, an upper display panel 36, and a liquid crystal layer (not shown) interposed therebetween.

A display device 1 according to an embodiment of the invention includes a lenticular sheet 100a, a display panel assembly 20, a backlight assembly 10, an intermediate frame 50, an upper housing 40, and a lower housing 95.

The display panel assembly 20 includes a display panel 30 including the lower display panel 31 and the upper display panel 36, a liquid crystal layer (not shown), a gate driving integrated circuit (IC) 21, a data chip film package 22, and a printed circuit board 23.

The display panel 30 includes the lower display panel 31 having gate lines (not shown), data lines (not shown), the thin film transistor array, and pixel electrodes, and the upper display panel 36 that includes color filters, black matrices, and a common electrode and is opposite to the lower display panel 31. For example, the color filters and the common electrode may be formed on the lower display panel 31. The lenticular sheet 100 having the first cylindrical lenses 110 formed on the upper surface thereof is arranged on the display panel 30.

The gate driving IC 21 is formed on the lower display panel 31 so as to be connected to the gate lines (not shown) formed on the lower display panel 31. The data chip film package 22 is connected to the data lines (not shown) formed on the lower display panel 31. The data chip film package 22 includes a wiring pattern having a semiconductor chip formed on a base film and a tape automated bonding (TAB) tape bonded thereto by a TAB technique. Examples of the chip film package include a tape carrier package (TCP) and a chip-on-film (COF). However, the above-mentioned chip film packages are merely illustrative examples.

The printed circuit board 23 is provided with various driving parts that process both the gate driving signals input to the gate driving IC 21 and the data driving signals input to the data chip film package 22.

The backlight assembly 10 includes an optical sheet 60, a light guide plate 70, a light source 80, and a reflecting sheet 90.

The light guide plate 70 guides light emitted from the light source 80 to the display panel assembly 20. The light guide plate 70 is formed of a transparent plastic material, such as acryl, and guides light emitted from the light source to the display panel 30 provided on the light guide plate.

The light source 80 emits light to the display panel 30, and one or more light sources 80 are provided in the backlight assembly 10. A point light source, such as a light emitting diode (LED), may be used as the light source 80.

The reflecting sheet 90 is provided on the lower surface of the light guide plate 70 and reflects light emitted from the lower surface of the light guide plate 70 upward. The reflecting sheet 90 is provided on the lower surface of the light guide plate 70, and reflects light emitted from the lower surface of the light guide plate 70 into the light guide plate 70 or to the display panel 30 through the light guide plate 70, thereby minimizing the loss of light emitted from the light source 80 and improving the uniformity of light emitted to the display panel 30 through the light guide plate 70.

The optical sheet 60 is provided on the upper surface of the light guide plate 70, and diffuses and focuses light from the light guide plate 70. The optical sheet 60 may include at least one of a diffusion sheet, a prism sheet, and a protective sheet. The diffusion sheet diffuses light from the light guide plate 70 to prevent light from being partially concentrated. The prism sheet has triangular prisms arranged in a predetermined array on the upper surface thereof, and focuses light diffused by the diffusion sheet in a direction that is vertical to the display panel 30. Therefore, most light passing through the prism sheet travels in the vertical direction. As a result, uniform brightness distribution is obtained on the protective sheet. In addition, the protective sheet not only protects the surface of the prism sheet, but also diffuses light to obtain uniform light distribution.

The reflecting sheet 90, the light source 80, the light guide plate 70, and the optical sheet 60 are sequentially accommodated in the lower housing 95. The lower housing 95 may be formed of a metallic material in order to ensure sufficient rigidity against an external impact and a sufficient ground performance.

The intermediate frame 50 includes four side walls forming a rectangular frame. The intermediate frame 50 is fitted to the lower housing 95 so as to be arranged outside the side wall of the lower housing 95.

The display panel 30 is arranged on the protective sheet and mounted in the intermediate frame 50. The intermediate frame 50 may be formed of a plastic mold frame in order to prevent parts fixed by the intermediate frame 50 from being damaged.

The upper housing 40 is coupled to the lower housing 95 from the upper side so as to cover the upper surface of the display panel 30 accommodated in the intermediate frame 50. A window allowing the liquid crystal panel 30 to be exposed to the outside is formed in the upper surface of the upper housing 40. The upper housing 40 may be formed of a metallic material in order to ensure sufficient rigidity against an external impact and a sufficient ground performance, similar to the lower housing 95. The upper housing 40 may be coupled to the lower housing 95 by hooks.

The printed circuit board 23 of the display panel assembly 20 is bent along the outer surface of the intermediate frame 50 and mounted to the side or rear surface of the lower housing 95.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A display device comprising:
a display panel having a plurality of pixels provided therein and displaying an image;
a lenticular sheet provided on the display panel and having a plurality of first cylindrical lenses arranged on one surface and a second cylindrical lens for focusing light arranged on the other surface; and
a backlight assembly provided below the display panel and emitting light to the display panel, wherein the first cylindrical lenses and the second cylindrical lens are arranged such that a lens axes thereof are parallel to each other.

2. The display device of claim 1, wherein a curvature radius of the second cylindrical lens is decreased as a distance from the center of the lens axis is increased.

3. The display device of claim 1, wherein the display panel faces the second cylindrical lens.

4. The display device of claim 1, wherein the second cylindrical lens is a convex lens.

5. The display device of claim 1, wherein the second cylindrical lens is a Fresnel lens.

6. The display device of claim 1, wherein the shape of each of the first cylindrical lenses and a shape of the second cylindrical lens in a cross-sectional view form a portion of a circle.

7. The display device of claim 1, wherein a curvature radius of the second cylindrical lens is larger than that of the first cylindrical lens.

8. The display device of claim 1, wherein the lenticular sheet includes one second cylindrical lens that overlaps all of the plurality of first cylindrical lenses.

9. The display device of claim 1, wherein at least one of the first cylindrical lens and the second cylindrical lens is a liquid lens.

10. A display device comprising:
a display panel having a plurality of pixels provided therein and displaying an image;
a lenticular sheet provided on the display panel and having a plurality of first cylindrical lenses arranged on one surface;
a lens sheet provided between the lenticular sheet and the display panel, wherein the lens sheet has a second cylindrical lens for focusing light arranged on one surface; and
a backlight assembly provided below the display panel and emitting light to the display panel, wherein the first cylindrical lenses and the second cylindrical lens are arranged such that a lens axes thereof are parallel to each other.

11. The display device of claim 10, wherein a curvature radius of the second cylindrical lens is decreased as a distance from the center of the lens axis is increased.

12. The display device of claim 10, wherein the display panel faces the second cylindrical lens.

13. The display device of claim 10, wherein the second cylindrical lens is a convex lens.

14. The display device of claim 10, wherein a convex surface of the second cylindrical lens faces the lenticular sheet.

15. The display device of claim 10, wherein the second cylindrical lens is a Fresnel lens.

16. The display device of claim 10, wherein a shape of each of the first cylindrical lenses and the shape of the second cylindrical lens in a cross-sectional view form a portion of a circle.

17. The display device of claim 10, wherein a curvature radius of the second cylindrical lens is larger than that of the first cylindrical lens.

18. The display device of claim 10, wherein the lenticular sheet includes one second cylindrical lens that overlaps all of the plurality of first cylindrical lenses.

19. The display device of claim 10, wherein at least one of the first cylindrical lens and the second cylindrical lens is a liquid lens.

20. The display device of claim 19, wherein at least one of the lenticular sheet and the lens sheet is a lens array substrate on which the liquid lenses are arranged in an array pattern
